(19) United States
(12) Patent Application Publication
(10) Pub. No.: US 2012/0030045 A1
(43) Pub. Date: Feb. 2, 2012

(54) Sales Tax Interface

(76) Inventor: Roy R. SMITH, III, Sugar Land, TX (US)

(21) Appl. No.: 13/194,965

(22) Filed: Jul. 31, 2011

Related U.S. Application Data
(60) Provisional application No. 61/369,546, filed on Jul. 30, 2010.
(60) Provisional application No. 61/415,335, filed on Nov. 18, 2010.

(51) Int. Cl. G06Q 20/00

(52) U.S. Cl. 705/19

(57) ABSTRACT

An interface to be integrated with remote merchant financial transaction systems to streamline the sales tax collection process. The present invention provides online merchants, call centers, and the alike the ability to accurately collect and report sales tax to the proper tax entities of the state, city, county and local municipality levels. The present invention is able automatically to provide the sales tax percentage and or fees, or calculate such based on consumer locations provided by their billing or shipping addresses. With different commodities having different tax rates, a universal classification code is utilized to distinguish specific tax rates for each tax entity as well. The present invention provides merchants with the ability to report sales tax to a plurality of tax entities in a single transaction. All tax entities are paid the owed sales taxes and associated fees automatically by the sales tax interface on behalf of the merchants registered with the present invention.

The current application claims a priority to the U.S. Provisional Patent application Ser. No. 61/369,546 filed on Jul. 30, 2010 and the U.S. Provisional Patent application Ser. No. 61/415,335 filed on Nov. 18, 2010.

### FIELD OF THE INVENTION

The present invention relates generally to a sales tax and fees interface. More specifically, the sales tax interface may be integrated with e-commerce merchant's shopping cart for convenient and easy processing of sales tax and fees. The present invention provides the sales tax percentage and fees for each individual transaction and in certain embodiments will calculate the sales taxes and other fees, all based upon the location of a consumer.

### BACKGROUND OF THE INVENTION

As states, counties, cities, and municipalities throughout the United States experience increasing budget challenges, these challenges are only magnified in the loss of sales tax revenues. This loss in sales tax is the result of the ever-increasing amount of commerce conducted over the internet, through call centers as well as mail order companies and other alternative means of commerce. The vast majority of this commerce is free of all sales tax and fees, and in those few cases where sales tax and fees are charged, it is paid to the state and local municipalities in which the Seller is located as opposed to the state and local municipalities in which the purchaser is located.

This current system creates an uneven playing field when it comes to the collection and non-collection of sales taxes and fees. A large online seller can locate their business in a city and state, which have favorable sales tax laws, that allow the seller to freely sell their goods and services without charging sales tax and when combined with free shipping is more times than not the lowest cost alternative to a buyer. It is this uneven playing field that not only applies additional competitive pressures on the locally owned and operated brick and mortar stores throughout the United States, i.e. a local flower shop competing against a large on-line seller, it also reduces the amount of sales tax revenue which would have otherwise been collected in helping to fund local services for both the locally owned flower shop as well as the purchaser.

From the state level down, municipalities all across the United States have expressed the desire to change current laws, thus requiring online sellers and alike, to begin collecting sales tax on all taxable transactions. However, remote sellers have been resistant to such changes in tax law given the complexity in that each and every online and alike seller, no matter how large or small, would then be required to register with, collect taxes for, report to and pay these sales taxes on an individual basis, to the many tens of thousands of municipalities across the entire United States. It is this very complexity, which has prevented the federal government from changing current tax laws, in granting states the authority to collect sales taxes and fees on interstate commerce, thus leaving both states and local municipalities throughout the U.S. with a base of ever-decreasing sales tax revenue.

The present invention eliminates the complexity of reporting and paying sales taxes to the tens of thousands of municipalities across the United States by providing an automated system for the collection, reporting and paying of sales tax and fees. The present invention is integrated with the merchant's website shopping cart, or in some embodiments, with the merchant's inventory control system software while either providing the sales tax percentage and fees, or doing so while also calculating the sales tax and fees for each sales transaction. The complexities of processing sales tax and fees for each sale transaction are passed onto the present invention by the merchant. The sales taxes and fees are collected during the transaction by the seller then periodically, transferred to the Sales Tax Interface, if not first having been collected directly by the Sales Tax Interface, before then being reported to and paid to the corresponding states and municipalities periodically.

### BRIEF DESCRIPTION OF THE DRAWINGS

FIG. 1 is an information flow and exchange chart of the embodiment of the present invention where the sales tax and fees are collected by the merchants and paid to the plurality of tax entities through the sales tax interface.

FIG. 2 is an information flow and exchange chart of the embodiment of the present invention where sales tax and fees are collected in separate transactions from that of the remote seller. The collected sales tax is directly transferred to the proper tax entities.

### DETAIL DESCRIPTIONS OF THE INVENTION

All illustrations of the drawings are for the purpose of describing selected versions of the present invention and are not intended to limit the scope of the present invention.

The present invention completely eliminates all complexities for online and alike sellers in the registration and compliance with states and the tens of thousands of municipalities throughout the United States in which sales taxes and fees must be collected and paid.

The present invention is a sales tax interface that provides e-commerce merchants and or remote sellers with the ability to collect and process sales tax and fees for the tens of thousands of individual municipalities throughout the United States. A single merchant may have a number of customers located in several different regions. With each customer being located in a region where there are multiple taxing authorities and municipalities, the sales tax rates and fees are dependent on the customer's location. As a result, to report and pay the sales tax and fees for each sales transaction, the sales tax interface is required to provide the sales tax rate and fees for each individual state, taxing authority and municipality. With the consumer basis being the entire nation for each e-commerce merchant and or remote seller, the present invention must provide the accurate sales tax rates and other associated fees. The present invention is able to keep track of every single sale transaction for a merchant, so to accurately distribute and pay that amount of sales tax and fees, which are collected for each state, and those municipalities and tax entities within each state.

To use the Sales Tax Interface, each merchant will first establish themselves as a customer for those services as provided by the Sale Tax Interface. In a single registration process with the sales tax interface, the online sellers and alike will be registered with all 50 secretaries of states. Once the registration process is complete, and the proper communications between the Sales Tax Interface and the remote seller is established. Sellers will then be able to calculate and collect the proper sales tax and fees which are owed to the state, county and city in which the purchaser is located and/or the location in which the goods and services will be delivered to.

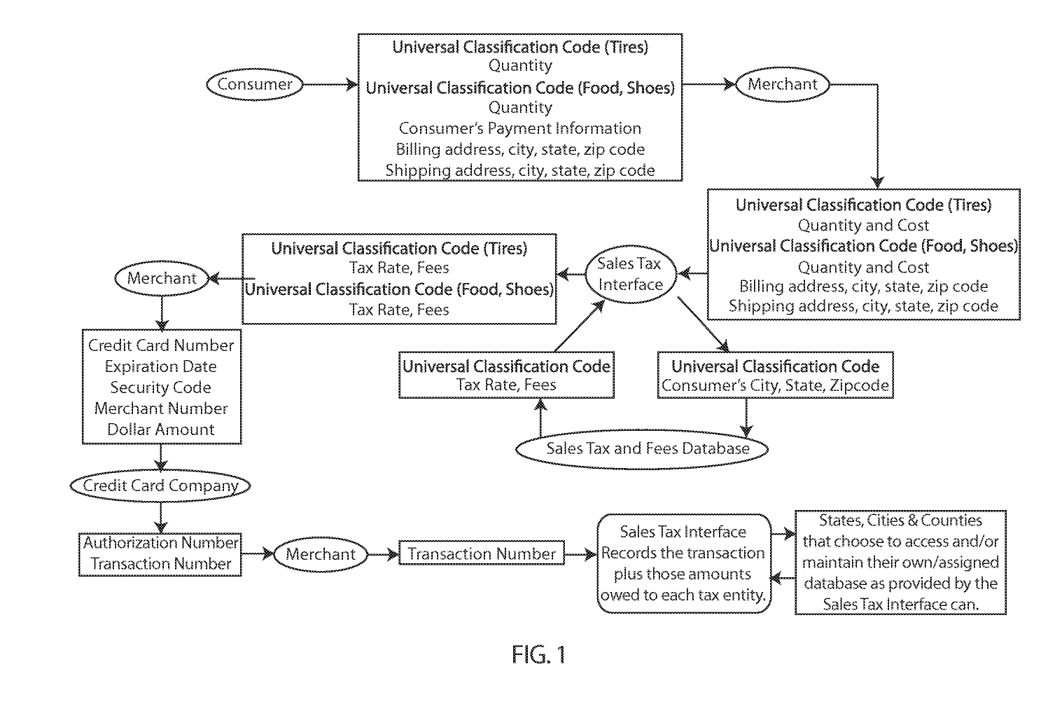

In reference to FIG. 1, the sales tax interface is able to eliminate all complexities for on-line and alike sellers in that it provides an instant means and method for calculating and collecting sales tax and fees at the moment a transaction is conducted. All sales tax and fees collected are later reported to and paid to the appropriate tax entities throughout the United States. Each reporting and payment of sales tax and fees are processed in a single transaction in behalf of the merchant. All reports and payments are processed electronically by the sales tax interface for each involved tax entity at predetermined times.

The sales tax interface is a secure web-based interface that is designed specifically for on-line sellers, call centers, websites, mail order companies, and any other remote merchant. The integration of the sales tax interface with each company's shopping cart, or proprietary transaction/inventory control system provides instant and accurate determination of sales tax and or fees that apply to a transaction between a consumer and a merchant depending on that location of the consumer and or the shipping location.

The sales tax interface may be integrated with any type of transaction system including a company's in-house proprietary system or third party financial transaction systems, such as a website's shopping cart. The sales tax interface embeds within any and all secure check-out/shopping cart services to provide sales tax and associated fees processing services. The merchant may also choose to use the sales tax interface for their secure check-out/shopping cart service, in which the collected sales tax and fees could be deposited into a separate sales tax interface account at the very moment in time a transaction is consummated.

Online merchants and alike will first register with the sales tax interface via a secure web-based interface. In turn, the sales tax interface will assign a merchant account number to each merchant, while registering each merchant with all 50 secretaries of state throughout the United States. As a result, merchants are then provided those services of the sales tax interface, which include but are not limited to the plurality of databases, which are unique to each individual taxing jurisdiction throughout the United States, as provide to each jurisdiction by the sales tax interface.

Based upon a purchaser's address and/or shipping address, the types of products and/or services being purchased as well as the price of those goods and services, the sales tax interface is able to provide the appropriate percentage of sales tax and or fees for a taxable transaction, so that the seller is able to complete the transaction while collecting the accurate amount of sales taxes and fees for each individual transaction. Each time a seller completes an order or sale, the seller communicates the detailed transaction data of that transaction to the sales tax interface, where the data is recorded.

From the transaction data, the sales tax interface records that data to the merchant's account which is necessary in order to properly record those taxes and fees collected for and payable to the polarity of tax jurisdictions. This recorded data will includes, but not be limited to, the customer's purchased product information as well as the shipping and payment information.

Different types of remote merchants may use the sales tax interface by employing different methods. For example, a seller, such as a call center, may choose to embed the sales tax interface within their proprietary in house computer system. A large on-line seller may choose to do the same while also embedding the sales tax interface within their proprietary online and secured check-out/shopping cart. Other on-line sellers may choose to use an approved sales tax interface vendor, which provides secure checkout/shopping cart services, or even yet simply use the sales tax interface as both their sales tax solution provider as well as for secure check-out/shopping cart services.

In reference to FIG. 1, the sales tax interface works in conjunction with information provided by the seller, purchaser and applicable tax entities. The sales tax interface will first reference the items via item number as well as quantity for each item as provided by the seller. This information is matched to the information provided by the purchaser including but not limited to their shipping and billing addresses city, state, county, zip code and etc. The information provided by the purchaser will be used to determine the proper tax entities. The sales tax interface will then used the information provided by the purchaser to identify proper sales tax rates and/or fees that the purchaser is required to pay, if any. The sales tax interface is able to identify the proper sales tax rates and or fees by utilizing the billing address and or shipping address applicable to tax entities, i.e. federal, state, city, county and or municipalities within the United States and or abroad. More specifically, the sales tax interface accesses a sales tax and fees database to retrieve tax rates data and fee rates data as they apply to each product or service's unique item number. As some tax rates vary depending on the type of product purchased, as well as price, commodity codes are used to ensure accurate identification of goods and services and to provide the accurate percentage of sales tax and fees, so that the seller can calculate, accurately the total amount of sale tax and or fees, which must be collected.

Such item numbers and/or universal classification codes have been established and or instituted by organizations such as the United Nations Standard Products and Services Code (UNSPSC). The UNSPSC has developed and manages a system of universal classification codes, specifically for the use of cities, states and governments as well as industry, for the purpose of spend analyses, and is the, universal standard, in use throughout the world. It is important to understand that these, universal classification codes, as developed by the UNSPSC, is not related to and should not be confused with, UPC codes and or other bar code technology. Unlike UPC codes and or bar code technology, these universal classification codes as created, managed and maintained by the UNSPSC are not marked on products or packaging. Not all vendors, wholesalers or manufactures, utilize and or incorporate UPC codes and or bar code technology within their business, nor do all retailers, or remote sellers. It is for this reason, that the sales tax interface utilizes a universal classification code system in order to provide services to both large and small remote sellers.

In terms of identifying goods and services, the universal classification codes as developed, managed, and maintained by the UNSPSC, go far beyond identifying a pair of shoes as a pair of shoes. But instead, identifies up to 63 or more classifications and or types of footwear, up to 100 or more classifications and or varieties of apples and so on. As new products and or classifications of goods and services enter the market place, the UNSPSC through it's management of the classification database assigns classification numbers to these new goods and services as needed and or upon request. This universal classification system as provided by the UNSPSC provides clarity for the sales tax interface as to what goods and services are taxable and if fees must be applied. For example, clothing and shoes are typically taxable, but not in all cities and states. For those states in which clothing and shoes are taxable, they often offer a temporary “tax holiday” on those items for a certain number of days each year. The sales tax interface utilizes the universal classification database as provided by the UNSPSC to accurately identify goods and services and to manage the vast complexities as to what is and is not taxable. Once an item is identified through the classification database, the taxable address for the purchase is then matched with the appropriate tax entities, the items price and date of the purchase is then check against any sales tax holidays and/or alike, prior to providing the applicable sales tax percentage and or fees, if any. Once completed, the sales tax interface then returns the percentage of sales tax as well as any additional fees, so that the purchase transaction can be completed. In consideration of the type of sales data that the sales tax interface will be recording, such data will prove usefully to both industry and government alike. As a result, this data will generate additional revenue sources for the sales tax interface.

Using the universal classification codes will allow the sales tax interface to collect more detailed sales data. Each time a transaction is executed, the sales data is recorded by the sales tax interface into a sales database. Over time this sales data in the sales database can provide important information in regards to the tracking of sales, trends, and economic data for use by business or government. The sales tax interface will provide access to data, tools, and reports to users for the purpose of sales and marketing analysis. The users are also provided with tools to customize such reports and data collection for the purpose of tracking and analyzing sales and trends. Reports can be automated with users scheduling their reports to be automatically generated and delivered at predetermined time periods. The reports, produced by the sales tax interface include but are not limited to the following:
1. Sales trends, what classification codes are trending up, verses those that are trending down.
2. Top 10 lists, which classification codes are best selling via on-line, call centers and like merchants.
3. Top classification codes purchased on a state by states basis.
4. The top 10 states for certain classification codes.
5. Which states and cities are spending the most money on-line and on what classification codes?
6. How much money is being spent on-line on a week-to-week, month-to-month, or year-to-year basis?
7. Sales comparisons in dollars, by classification code and units sold.
8. Customized reports to where the sales tax interface analyzes those classification codes sold by an individual user/remote seller, while providing and identifying for that user/retailer those cities, states, etc. that have the strongest demand for such classification codes.

In addition to the utilization of the universal classification codes system as provided by the UNSPSC, the sales tax interface is able to reference the purchaser's shipping address or billing address to apply the proper sales tax rates and additional fees (i.e. disposal fee per tire purchased) associated with the specific items purchased. With each purchase, the sales tax interface receives transaction data from the merchant account. The transaction data received by the merchant account includes customer account data and the sales data. With the purchaser's shipping address or billing address provided by the customer account data and the universal classification code of the items being purchased in the transaction provided by the sales data, the sales tax interface is able to access the sales tax and fees database to retrieve the proper tax rates data and fees rates data. The sales tax interface then calculates and provides the associated taxes and fees for the sales data transaction using the tax and fees rate data. With the associated sales tax and the associated fees provided, the sales data is updated by the sales tax interface to the shopping cart for the purchaser to review. The purchaser is able to review the sales data as well as the sales tax and fees data in the check-out area/shopping cart of the website and or as provided by the remote seller. Once the transaction is completed and validated, the merchant communicates this data to the sales tax interface where it records the transaction as well as the individual amounts of sales tax and fees that are owed to each individual tax entity from federal, state, county, city and local municipality levels. The completed transaction results in the proper amount of sales tax and or fees being collected by the merchant.

The associated taxes and the associated fees with respect to the transaction are then collected and transferred, from the customer account to the merchant account along with those proceeds for such goods and services, as part of the total transaction.

On a weekly, monthly, quarterly, annual basis or any other predetermined time periods, as required by law, the sales tax interface would generate a sales tax report on behalf of the seller. These sales tax reports will provide all necessary details as well as the sales tax and fee amounts owed to each individual tax entity from the federal, state, county, city, and local municipality level. After review of the sales tax report in regards to those sales tax and fees collected and owning, sellers would then execute a single transaction via electronic means to their individual sales tax interface account. This deposit would include any penalties, interest or fees, in order to distribute and satisfy that amount owed to tax entities of the report period. The penalties, interests, and fees would include, but is not limited to, late or delinquent tax and/or fee payments.

The proper amount of collected sales tax, fees, penalties, interest, and any other associated fees deposited within their merchant account with the sales tax interface is held in trust by the sales tax interface. The sales tax interface would then proceed with all reporting as required by law while forwarding all sales tax and fees along with any applicable penalties, interest, and etc. on behalf of the seller, to any and all tax entities from the federal state, county, city, and local municipality levels. The sellers are provided with receipts, confirmations, and or real time access to their individual sales tax interface account via a secure web-based interface. The Sales Tax Interface will allow for tax exempt transactions while requiring the purchaser to provide all necessary information as required by law, as well as process refunds and adjustments as permitted by the seller.

The sales tax interface will provide assistance to tax entities in helping remote sellers to accurately apply and collect the appropriate sales tax, taxes and fees for their jurisdiction. The tax entities are provided with the means to register with the sales tax interface. The registration of each tax entity would require all necessary information such as, but is not limited to, tax assessor collector, contact information, location, bank wire instruction and reporting requirements, while e-signing all documentation as allowable by law.

All tax entities from federal, city, state, county and local municipality levels would be provided with access to the Sales Tax Interface, comprising of those universal classification codes as provided by the UNSPSC. From here, tax entities will have access to and/or have the ability to, monitor and control tax rates and fees for those goods and services, which are sold by remote sellers, and within their jurisdictional boundaries. These tax entities, if they so choose, will have the ability to choose what is or is not taxable, at what tax rate, if additional fees apply, establish sales tax holiday all while monitoring in real-time, their hour by hour and day to day collection of sales tax and fees as recorded by the sales tax interface. Additionally, tax entities will have at their disposal, all data as recorded by the sales tax interface for the purpose of analysis, reports, and auditing of both the sales tax interface as well as each individual remote seller which uses the sales tax interface as their sales tax service provider. Each registered tax entity is provided with the means, so that they may provide the percentage of sales tax and amount of any applicable fees as well as any necessary methods and/or formulas and calculations of taxes and fees, which must be applied to taxable sales within their jurisdiction.

Additionally, tax entities will be able to establish, monitor and control information and data such as, but not limited to, start and conclusion dates for sales tax and fee holidays, the specific goods, services and dollar amounts which are included and/or excluded from such holidays, activate new sales tax and/or fees for goods and service in which sales tax and fees have never been collected, or eliminate such tax and fees for goods and services, while applying commencement dates for such changes. The required information in regards to sales tax exemption, calculations for fines, penalties, fees and alike in regards to late or delinquent payment of sales tax and fees are established and updated by the tax entities.

With the sales tax interface, tax entities for the first time, will be afforded the ability in applying tax, sales tax, income tax and or fees for goods and services which if not for the Internet such goods and services may very well not exists. Such as Internet based dating sites, Internet based tobacco sites, Internet based gambling sites and Internet based adult sites. The sales tax interface will also afford the ability for tax entities to once again capture that tax revenue, which at one time did exist throughout their jurisdictions, but now have vacated brick and mortar locations, transitioning to Internet only, or Internet dominate business models such as for movie and/or video rental. The taxing entities will also be able to track sales tax collection on a real time basis via a secure web-based interface.

The sales tax interface services can be applied to international transactions as well, no matter if it be the seller, or the consumer, which is located in or outside of the U.S.

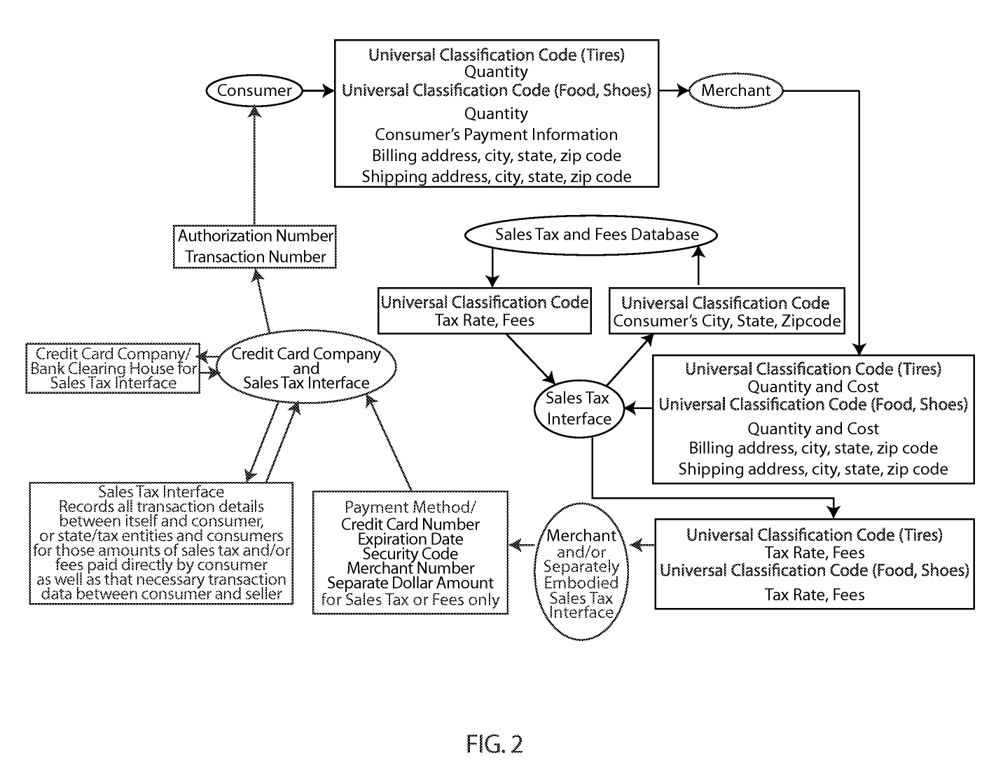

In reference to FIG. 2, in this embodiment of the invention, the seller need not and does not collect sales tax and or fees. Instead, within the same shopping cart transaction and/or a separately embodied Sales Tax Interface system, the consumer, when making a taxable transaction, would be provided by the Sales Tax Interface the sales tax percentage and/or fees along with the itemized calculation of sales tax and or fees and the total of sales tax and/or fees. This total of sales tax and/or fees will be immediately due, charged to them and paid by them in a separate transaction from that of any transaction involving the remote seller. This transaction/collection of sales tax and fees is executed by the appropriate state/tax entities, and/or the sales tax interface acting in behalf of the appropriate state/tax entities, at the very moment in time they execute their transaction with the remote seller, whether it be an on-line/internet seller, call center and or non-traditional brick and mortar store. As a result, for the remote seller, the obligation of accurately collection sales tax and or fees, while then having to forward such to the appropriate states and or tax entities, is completely eliminated.

In this embodiment, the seller's shopping cart/system transmits to the sales tax interface, that data, which includes but is not limited to, the seller's merchant number, universal classification code for each item, dollar amounts for each item, and the customer's address, city, state, and zip code. The sales tax interface then provides to the seller's shopping cart/system or the separately embodied sales tax interface system that data, which includes but is not limited to, tax percentages and/or fees, itemized calculations of sale tax and/or fees and total of sales tax and/or fees.

At the point in time a customer begins to execute a purchase with the remote seller, both the seller and the sales tax interface must then process the two separate transactions via that payment method which has been provided by the customer. The seller will of course process that amount which is due and owing for the goods and services. The sale tax interface will of course process that amount which is due and owing in regards to that amount of sales tax and fees, which must be collect against that purchase with the remote seller. Once both transactions are cleared and recorded by the sales tax interface, confirmation, record, and/or receipt is provided to the customer via normal electronic means. As a result, the burden to collect the proper sales tax and fees are removed from the seller, and are instead collected directly from the consumer by the sales tax interface and in behalf of the appropriate tax entities.

Although the invention has been explained in relation to its preferred embodiment, it is to be understood that many other possible modifications and variations can be made without departing from the spirit and scope of the invention as hereinafter claimed.

What is claimed is:

1. A method of incorporating sales tax into a remote transaction by executing computer-executable instructions stored on a non-transitory computer-readable medium, the method comprises the steps of:
providing a merchant account;
providing a plurality of tax entity databases;
providing a sales tax and fees database;
receiving transaction data from the merchant account, wherein the transaction data includes customer account data and sale data;
accessing the sales tax and fees database;
retrieving tax rates data and fee rates data from the sales tax and fees database;
providing sales tax percentages and fees to be used in the calculation of a transaction between a remote seller and customer;
calculating of associated taxes for the sale data using the tax rates data;
calculating of associated fees for the sale data using the fee rates data;
updating of sale data with the associated taxes and the associated fees;
recording of the sale data into a sales database;
transferring of the associated taxes and the associated fees, wherein the associated taxes and the associated fees are withdrew from the merchant account and deposited to associated tax entity accounts;
creating of confirmations receipts when the distribution of the associated taxes and the associated fees has been completed;
generating of a sales report; and
providing access to the sales reports.

2. The method of incorporating sales tax into a remote transaction by executing computer-executable instructions stored on a non-transitory computer-readable medium, the method as claimed in claim 1 comprises,
providing a universal classification code database, wherein the classification database is a universal commodity classifier analogous to that of the United Nations Standard Products and Services Code; and
accessing and retrieving of a product or service's universal classification code for the sales data, wherein the product or service's universal classification code is associated with the tax and fee rates of a specific tax entity.

3. The method of incorporating sales tax into a remote transaction by executing computer-executable instructions stored on a non-transitory computer-readable medium, the method as claimed in claim 2 comprises,
providing purchase data by the sales data; and
the tax and fee rates data is dependent on a product universal classification code or a service's universal classification code of the purchase data, and the customer account data.

4. The method of incorporating sales tax into a remote transaction by executing computer-executable instructions stored on a non-transitory computer-readable medium, the method as claimed in claim 1 comprises,
generating alerts and reminders of tax notifications, wherein tax notifications include upcoming tax holidays.

5. The method of incorporating sales tax into a remote transaction by executing computer-executable instructions stored on a non-transitory computer-readable medium, the method as claimed in claim 1 comprises,
generating customized sales report; and
analyzing of the recorded sales data in the sales database to generate the customized sales report, wherein the customized sales report include sales trends, universal classification codes sales on state by state basis, top states for specific universal classification codes, locations with most money spent on-line, money spent per location on periodic basis.

6. The method of incorporating sales tax into a remote transaction by executing computer-executable instructions stored on a non-transitory computer-readable medium, the method as claimed in claim 1 comprises,
updating the sales tax and fee database with updated tax rate information at predetermined schedules, wherein the updated tax rate information includes updated tax rates, taxable products, and tax holidays.

7. A method of incorporating sales tax into a remote transaction by executing computer-executable instructions stored on a non-transitory computer-readable medium, the method comprises the steps of:
providing a merchant account;
providing a plurality of tax entity databases;
providing a sales tax and fees database;
receiving transaction data from the merchant account, wherein the transaction data includes customer account data and sale data;
accessing the sales tax and fees database;
retrieving tax rates data and fee rates data from the sales tax and fees database;
providing sales tax percentages and fees to be used in the calculation of a transaction between a remote seller and customer;
calculating of associated taxes for the sale data using the tax rates data;
calculating of associated fees for the sale data using the fee rates data;
updating of sale data with the associated taxes and the associated fees;
recording of the sale data into a sales database;
transferring of sales tax funds, wherein sales tax funds is directly retrieved from a customer account to a tax entity account;
compiling of a sales report; and
providing means to access the sales reports.

8. The method of incorporating sales tax into a remote transaction by executing computer-executable instructions stored on a non-transitory computer-readable medium, the method as claimed in claim 7 comprises,
providing a universal classification code database, wherein the classification database is a universal commodity classifier analogous to that of the United Nations Standard Products and Services Code; and
accessing and retrieving of a product or service's universal classification code for the sales data, wherein the product or service's universal classification code is associated with the tax and fee rates of a specific tax entity.

9. The method of incorporating sales tax into a remote transaction by executing computer-executable instructions stored on a non-transitory computer-readable medium, the method as claimed in claim 8 comprises,
providing purchase data by the sales data; and
the tax and fee rates data is dependent on a product universal classification code or a service's universal classification code of the purchase data, and the customer account data.

10. The method of incorporating sales tax into a remote transaction by executing computer-executable instructions stored on a non-transitory computer-readable medium, the method as claimed in claim 7 comprises,
generating alerts and reminders of tax notifications, wherein tax notifications include upcoming tax holidays.

11. The method of incorporating sales tax into a remote transaction by executing computer-executable instructions stored on a non-transitory computer-readable medium, the method as claimed in claim 7 comprises,
generating customized sales report; and
analyzing of the recorded sales data in the sales database to generate the customized sales report, wherein the customized sales report include sales trends, universal classification codes sales on state by state basis, top states for specific universal classification codes, locations with most money spent on-line, money spent per location on periodic basis.

12. The method of incorporating sales tax into a remote transaction by executing computer-executable instructions stored on a non-transitory computer-readable medium, the method as claimed in claim 7 comprises,
updating the sales tax and fee database with updated tax rate information at predetermined schedules, wherein the updated tax rate information includes updated tax rates, taxable products, and tax holidays.

13. A method of incorporating sales tax into a remote transaction by executing computer-executable instructions stored on a non-transitory computer-readable medium, the method comprises the steps of:
providing a merchant account;
providing a plurality of tax entity databases;
providing a sales tax and fees database;
receiving transaction data from the merchant account, wherein the transaction data includes customer account data and sale data;
accessing the sales tax and fees database;
retrieving tax rates data and fee rates data from the sales tax and fees database;
providing sales tax percentages and fees to be used in the calculation of a transaction between a remote seller and customer;
calculating of associated taxes for the sale data using the tax rates data;
calculating of associated fees for the sale data using the fee rates data;
updating of sale data with the associated taxes and the associated fees;
recording of the sale data into a sales database;
distributing of the associated taxes and the associated fees, wherein the associated taxes and the associated fees are withdrew from the sales tax collection account and deposited to associated tax entity accounts in predetermined time periods
creating of confirmations receipts when the distribution of the associated taxes and the associated fees has been completed;
generating of a sales report;
providing access to the sales reports; and
generating alerts and reminders of tax notifications, wherein tax notifications include upcoming tax holidays.

14. The method of incorporating sales tax into a remote transaction by executing computer-executable instructions stored on a non-transitory computer-readable medium, the method as claimed in claim 13 comprises,
providing a universal classification code database, wherein the classification database is a universal commodity classifier analogous to that of the United Nations Standard Products and Services Code;
accessing and retrieving of a product or service's universal classification code for the sales data, wherein the product or service's universal classification code is associated with the tax and fee rates of a specific tax entity;
providing purchase data by the sales data; and
the tax and fee rates data is dependent on a product universal classification code or a service's universal classification code of the purchase data, and the customer account data.

15. The method of incorporating sales tax into a remote transaction by executing computer-executable instructions stored on a non-transitory computer-readable medium, the method as claimed in claim 1 comprises,
generating customized sales report; and
analyzing of the recorded sales data in the sales database to generate the customized sales report, wherein the customized sales report include sales trends, universal classification codes sales on state by state basis, top states for specific universal classification codes, locations with most money spent on-line, money spent per location on periodic basis.

16. The method of incorporating sales tax into a remote transaction by executing computer-executable instructions stored on a non-transitory computer-readable medium, the method as claimed in claim 1 comprises,
updating the sales tax and fee database with updated tax rate information at predetermined schedules, wherein the updated tax rate information includes updated tax rates, taxable products, and tax holidays.
